(19) United States
(12) Patent Application Publication
(10) Pub. No.: US 2014/0021316 A1
(43) Pub. Date: Jan. 23, 2014

(54) Arrester Bracket Assembly

(71) Applicants: Jonathan Oral Adams, Columbia, MO (US); James Russell Smith, Columbia, MO (US)

(72) Inventors: Jonathan Oral Adams, Columbia, MO (US); James Russell Smith, Columbia, MO (US)

(73) Assignee: HUBBELL INCORPORATED, Shelton, CT (US)

(21) Appl. No.: 13/550,797

(22) Filed: Jul. 17, 2012

(51) Int. Cl. F16M 13/02

(52) U.S. Cl. 248/316.6; 248/309.1

(57) ABSTRACT

A bracket assembly for mounting an electrical device to a support includes a bracket and a back plate. The bracket has first and second fastener openings. The second fastener opening is elongated. The back plate has third and fourth fastener openings. The third fastener opening is closed. The fourth fastener opening is elongated and open. A slot in the back plate provides access to the fourth fastener opening. A first fastener is received in the first and third fastener openings. A second fastener is received in the second and fourth fastener openings.

### FIELD OF THE INVENTION

The present invention relates generally to a bracket assembly for securing an electrical device to a support. More particularly, the present invention relates to a bracket assembly connectable to a support without being disassembled. Still more particularly, the present invention relates to a bracket assembly for securing a cutout arrester to a support including an elongated fastener opening in a back plate having a slot for accessing the elongated opening in which the slot is open in a direction to prevent accidental removal of the fastener from the elongated fastener opening.

### BACKGROUND OF THE INVENTION

Bracket assemblies are conventionally used for securing an electrical device to a support, such as a cutout arrester to a crossarm. Existing bracket assemblies include a front bracket member and a rear bracket member connected by two fasteners. All of the fastener openings in many existing bracket assemblies are closed, i.e., a fastener can only access the opening axially through the opening itself. Thus, if the bracket assembly is pre-assembled, it must be disassembled by a lineman at the support such that the bracket assembly can be secured to the support. Lineman typically wear bulky protective gloves, which make manipulating the fasteners and nuts difficult. Should the lineman remove the protective gloves to perform these tasks, additional steps are added to the installation task in addition to exposing the lineman's hands in a hazardous environment. Accordingly, a need exists for a bracket assembly for securing an electrical device to a support in which the bracket assembly does not need to be disassembled to be secured to the support.

Many existing bracket assemblies have an open fastener opening such that disassembly of the bracket assembly is not required to secure the bracket assembly to the support. However, the opening in the fastener opening is parallel to a longitudinal axis of the fastener opening. Thus, if the fastener becomes loose over time, the fastener can accidentally slide out the open end of the fastener opening. For example, the bracket assemblies disclosed in U.S. Pat. No. 6,283,425 to Liljevik and U.S. Pat. No. 7,918,425 to Rathbone et al. have fastener openings in which the open end is laterally aligned and parallel to the longitudinal axis of the fastener opening. Accordingly, a need exists for a bracket assembly having a slot for a fastener opening that extends in a direction not laterally aligned and parallel to the longitudinal axis of the fastener opening.

In some existing bracket assemblies, the upper fastener openings are the open fastener opening. This prevents the bracket assembly from being hung on the support during installation. The lineman has to support the bracket assembly with one hand while maneuvering the upper fastener into the open end of the fastener opening to secure the bracket assembly to the support. Accordingly, a need exists for a bracket assembly that can be hung on the support when securing the bracket assembly to the support, thereby providing quick and easy installation.

### SUMMARY OF THE INVENTION

An object of the present invention is to provide a bracket assembly that is quickly and easily secured to a support.

Another object of the present invention is to provide a bracket assembly that is connectable to supports of various sizes.

Another object of the present invention is to provide a bracket assembly that is not disassembled when being connected to a support.

Another object of the present invention is to provide a bracket assembly having an open fastener opening that is open in a direction not laterally aligned and parallel to a longitudinal axis of the fastener opening.

The foregoing objects are basically attained by a bracket assembly for mounting an electrical device to a support includes a bracket and a back plate. The bracket has first and second fastener openings. The second fastener opening is elongated. The back plate has third and fourth fastener openings. The third fastener opening is closed. The fourth fastener opening is elongated and open. A slot in the back plate provides access to the fourth fastener opening. A first fastener is received in the first and third fastener openings. A second fastener is received in the second and fourth fastener openings.

The foregoing objects are also basically attained by a bracket assembly for mounting an electrical device to a support including a substantially L-shaped bracket and a substantially planar back plate. The bracket has first and second legs. First and second laterally closed fastener openings are disposed in the first leg. The second fastener opening is elongated. The back plate has third and fourth fastener openings. The third fastener opening is laterally closed. The fourth fastener opening is elongated and open via a slot in the back plate that provides access to the fourth fastener opening and extends in a direction not parallel to a longitudinal axis of the fourth fastener opening. A first fastener is received in the first and third fastener openings. A second fastener is received in the second and fourth fastener openings.

The foregoing objects are also basically attained by a method of mounting an electrical device to a support with a bracket assembly. The bracket assembly is mounted on a support such that a first fastener contacts the support to support the bracket assembly on the support. A second fastener is moved through a slot and into a first elongated fastener opening, the slot being not parallel with a longitudinal axis of the first elongated fastener opening.

Objects, advantages, and salient features of the invention will become apparent from the following detailed description, which, taken in conjunction with the annexed drawings, discloses an exemplary embodiment of the present invention.

### BRIEF DESCRIPTION OF THE DRAWINGS

The above benefits and other advantages of the various embodiments of the present invention will be more apparent from the following detailed description of an exemplary embodiment of the present invention and from the accompanying drawing figures, in which:

FIG. 1 is a front perspective view of a bracket assembly in accordance with an exemplary embodiment of the present invention;

FIG. 2 is a front perspective view of a mounting bracket of the bracket assembly of FIG. 1;

FIG. 3 is a front elevational view of the mounting bracket of FIG. 2;

FIG. 4 is a front perspective view of a back plate of the bracket assembly of FIG. 1;

FIG. 5 is a front elevational view of the back plate of FIG. 4;

FIG. 6 is a front perspective view of the mounting bracket and back plate prior to being connected;

FIG. 7 is a front perspective view of the mounting bracket and back plate of FIG. 6 receiving an upper fastener;

FIG. 8 is a front perspective view of the mounting bracket and back plate of FIG. 7 in which the mounting bracket only receives a lower fastener;

FIG. 9 is a front perspective view of the mounting bracket and back plate of FIG. 8 in which the lower fastener is adjacent a lower end of a slot in the back plate;

FIG. 10 is a front perspective view of the mounting bracket and back plate of FIG. 9 in which the lower fastener is adjacent an upper end of the slot in the back plate;

FIG. 11 is a front perspective view of the bracket assembly disposed on a support prior to connecting the lower fastener to the back plate;

FIG. 12 is a front perspective view of the bracket assembly of FIG. 11 in which the lower fastener is adjacent the lower end of the slot in the back plate;

FIG. 13 is a front perspective view of the bracket assembly of FIG. 12 in which the lower fastener is adjacent the upper end of the slot in the back plate;

FIG. 14 is a side elevational view of the bracket assembly disposed on the support of FIG. 13;

FIG. 15 is a rear perspective view of the bracket assembly disposed on the support of FIG. 13;

FIG. 16 is a front perspective view of the bracket assembly secured to a support with an arrester connected thereto;

FIG. 17 is a side elevational view of the bracket assembly and arrester of FIG. 16; and

FIG. 18 is a rear perspective view of the bracket assembly and arrester of FIG. 16.

Throughout the drawings, like reference numerals will be understood to refer to like parts, components and structures.

### DETAILED DESCRIPTION OF EXEMPLARY EMBODIMENT

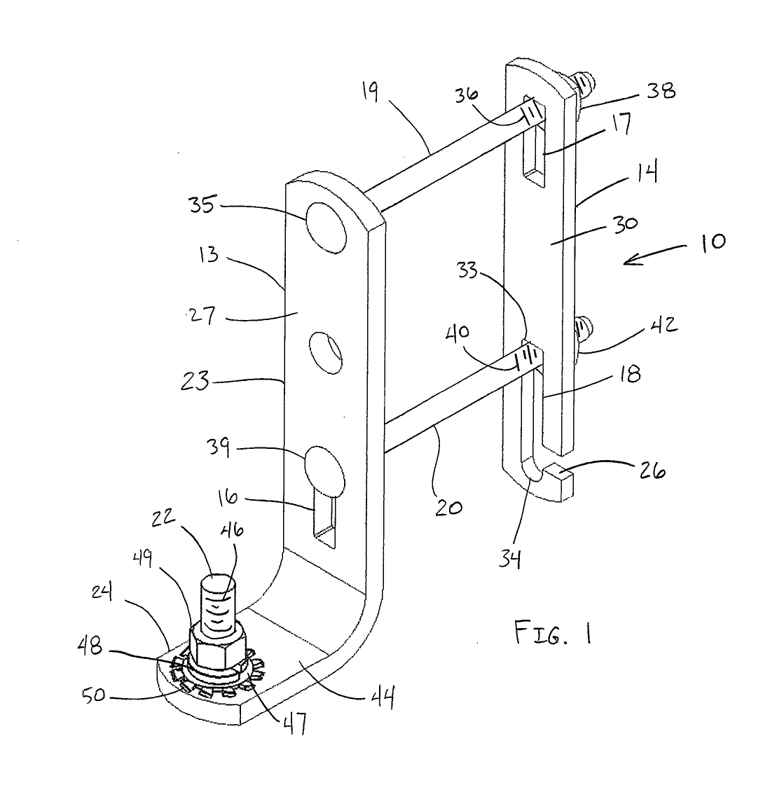

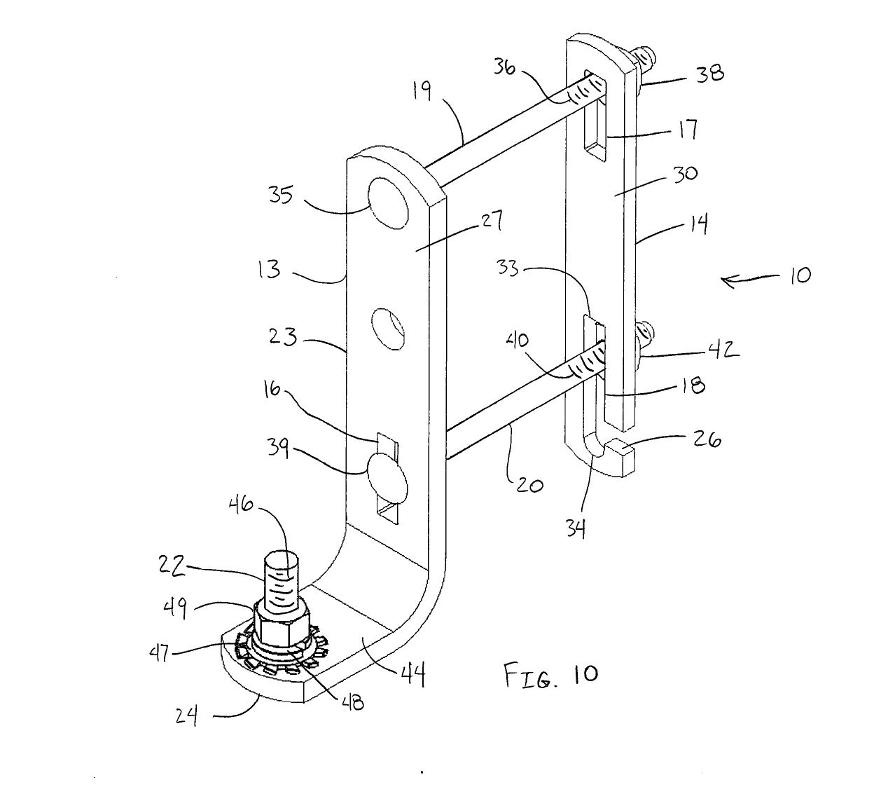

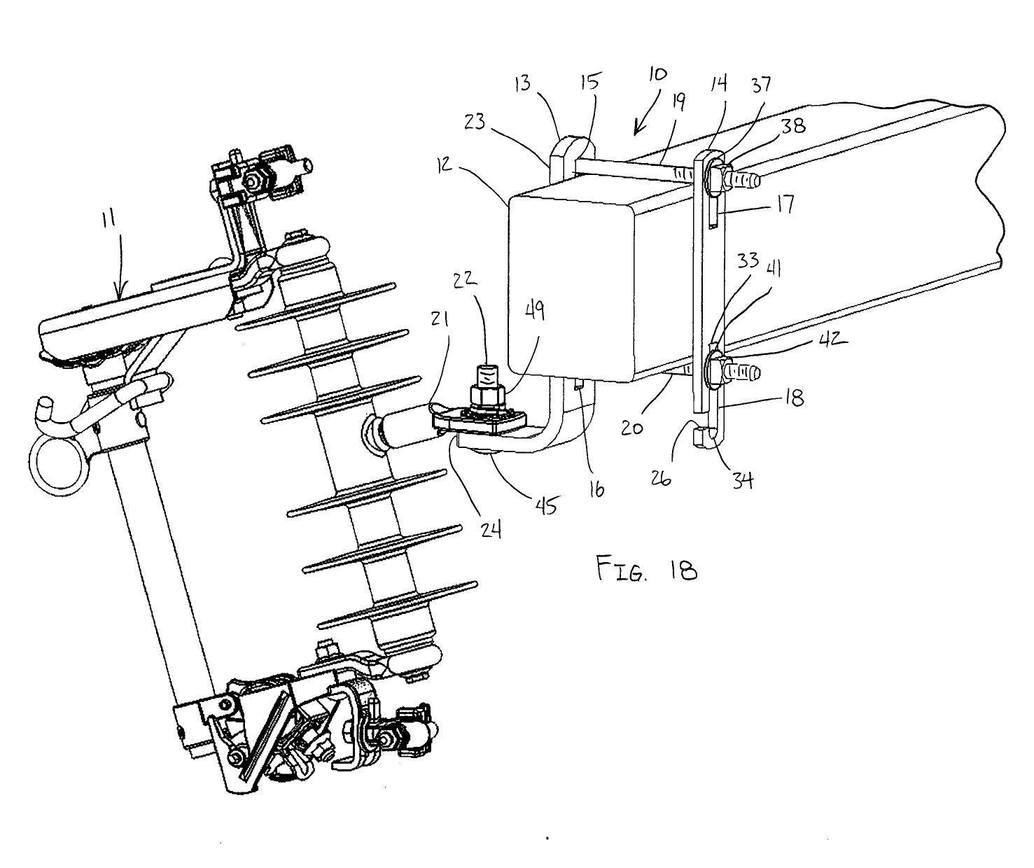

A bracket assembly 10 for mounting an electrical device 11, such as a cutout arrester, to a support 12, is shown in FIGS. 1-18. The bracket assembly 10 includes a mounting bracket 13 and a back plate 14. The mounting bracket 13 has a first circular and laterally closed fastener opening 15 and a second elongated and laterally closed fastener opening 16. The back plate 14 has a third fastener opening 17 and a fourth fastener opening 18. The third fastener 17 opening is laterally closed. The fourth fastener opening 18 is elongated and laterally open. A slot 26 in the back plate 14 provides lateral access to the fourth fastener opening 18. A first fastener 19 is receivable by the first and third fastener openings 15 and 17. A second fastener 20 is receivable by the second and fourth fastener openings 16 and 18.

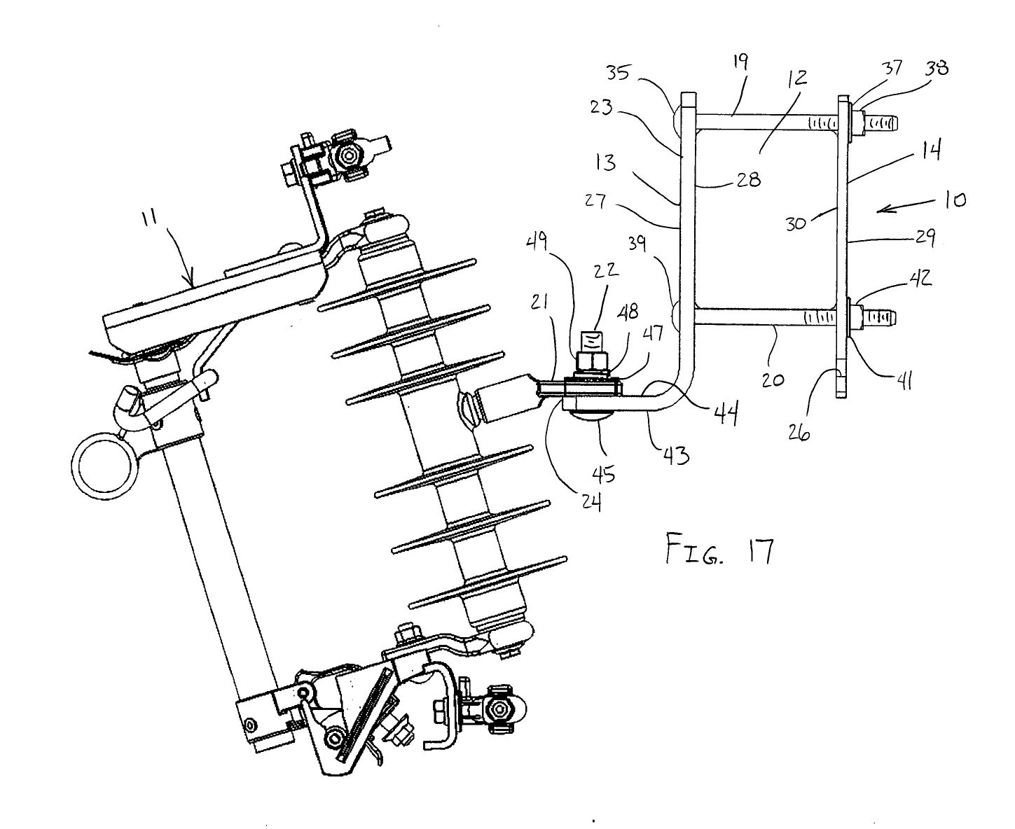

A conventional electrical device 11, such as a cutout arrester, is connected to a support with the bracket assembly 10 (FIGS. 16-18). The electrical device 11 has a mounting member 21 having a fastener opening therein for receiving a third fastener 22 to secure the electrical device to the bracket assembly 10.

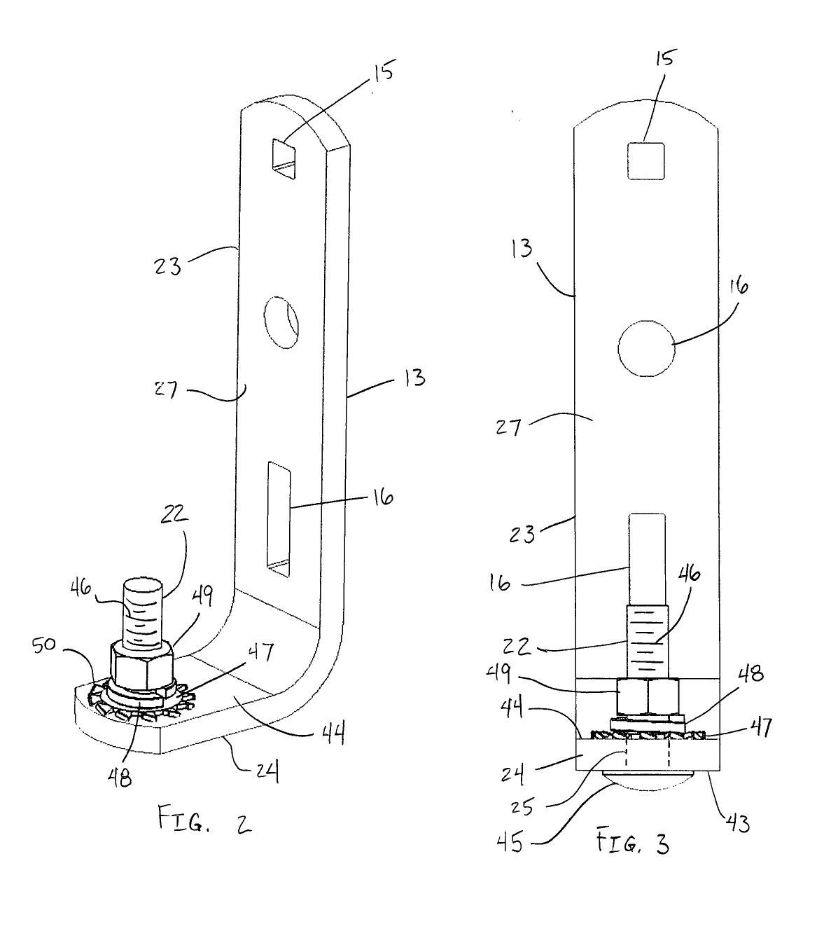

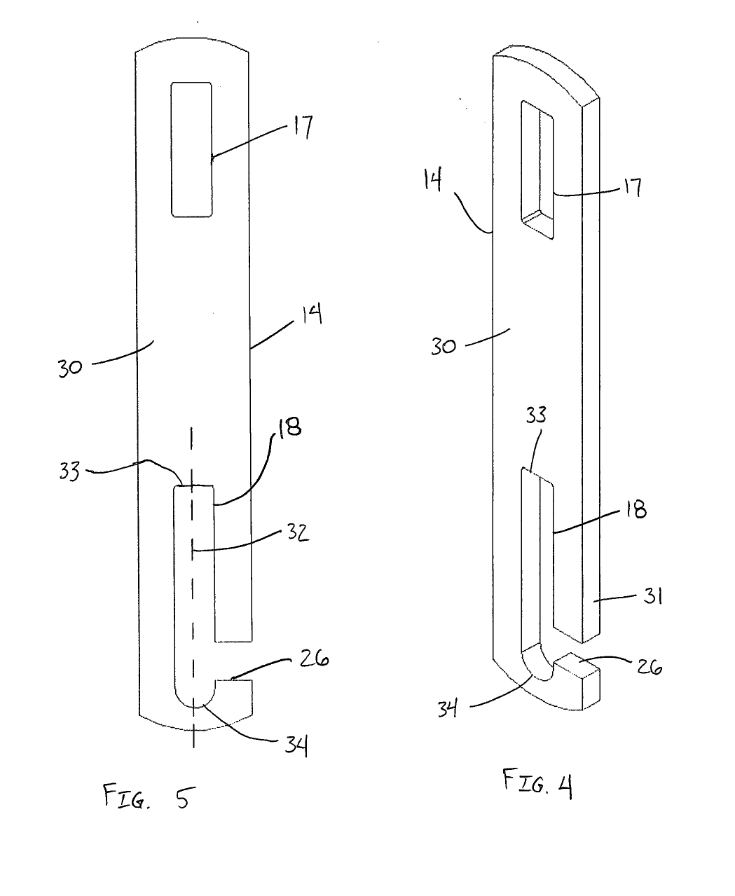

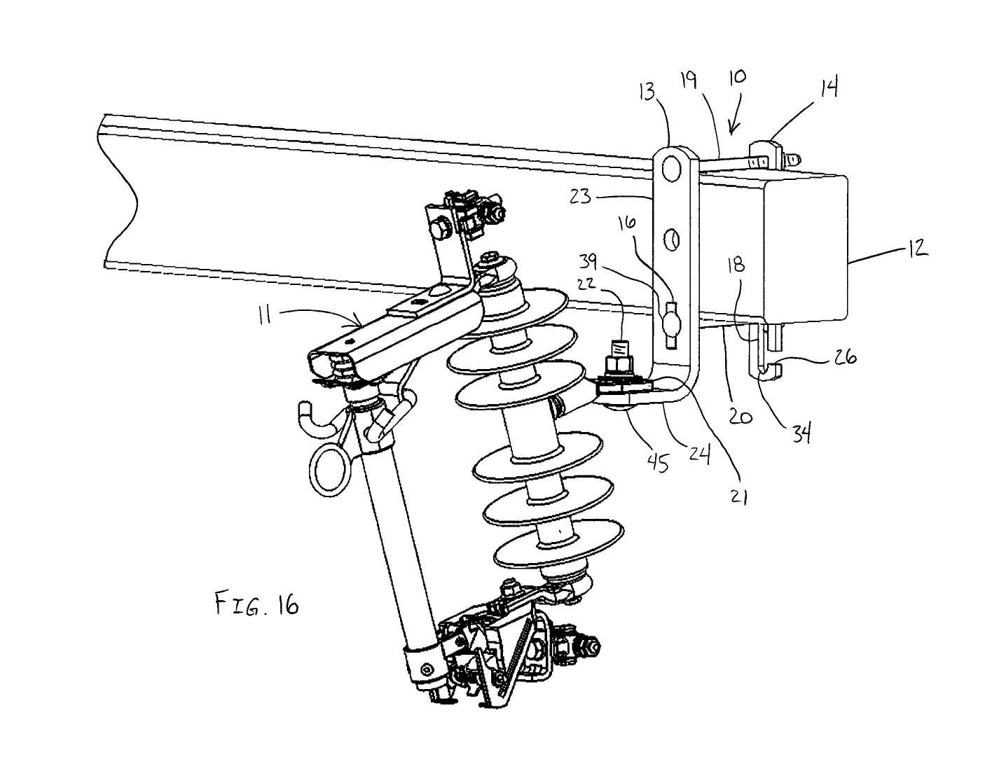

The mounting bracket 13, as shown in FIGS. 2 and 3, is preferably substantially L-shaped. A second leg 24 extends outwardly from an end of the first leg 23. The first and second fastener openings 15 and 16 are disposed in the first leg 23. A fifth circular and laterally closed fastener opening 25 is disposed in the second leg 24 of the bracket 13 adjacent the lower end thereof. Preferably, the first leg 23 is substantially planar. The first and second fastener openings 15 and 16 extend from an outer surface 27 to an inner surface 28 (FIG. 15) of the mounting bracket 13.

The first fastener opening 15 is fixed, i.e., sized to receive the first fastener 19 and substantially preventing lateral movement of the received fastener in the first fastener opening 19. The second fastener opening 16 is elongated to allow lateral movement of the second fastener 20 therein.

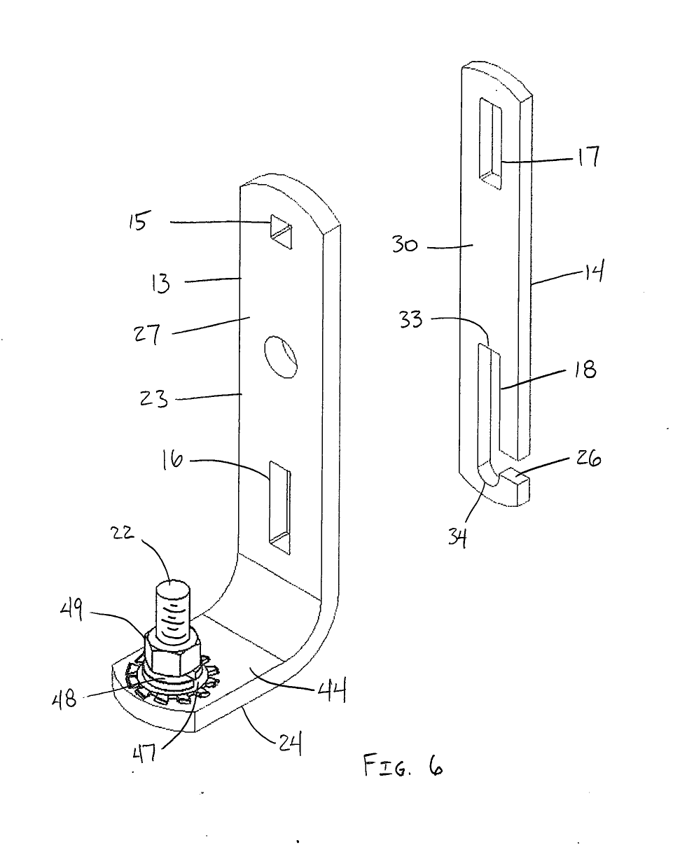

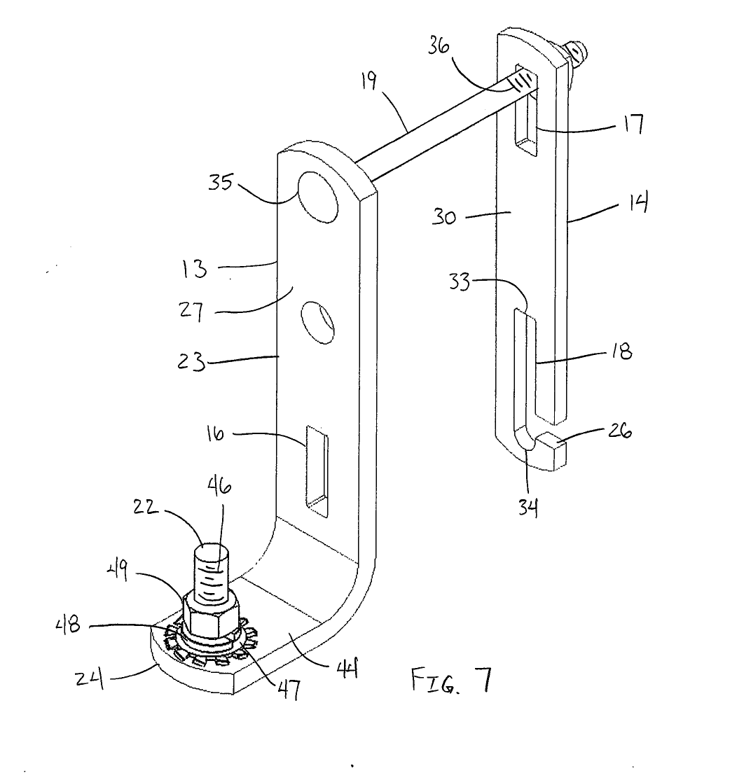

The back plate 14, as shown in FIGS. 4 and 5, is preferably substantially planar. The third and fourth fastener openings 17 and 18 extend from an outer surface 29 (FIG. 15) to an inner surface 30 and are adjacent the upper and lower ends thereof, respectively.

The third fastener opening 17 is laterally closed. Preferably, the third fastener opening 17 is elongated, although the third fastener opening can have any suitable shaped, such as non-elongated. The fourth fastener opening 18 is elongated and laterally open. A slot 26 extends from an edge 31 of the back plate 14 laterally to the fourth fastener opening 18 adjacent but spaced above its lower end 34 to provide access thereto. The slot 26 is not parallel to a longitudinal axis 32 of the fourth fastener opening 18 to prevent accidental removal of the second fastener 20 from the fourth fastener opening if the second fastener becomes loose. Preferably, the slot 26 is substantially perpendicular to the longitudinal axis 32 of the fourth fastener opening 18, as shown in FIG. 5. The slot 26 is preferably between a first end 33 and a second end 34 of the fourth fastener opening 18.

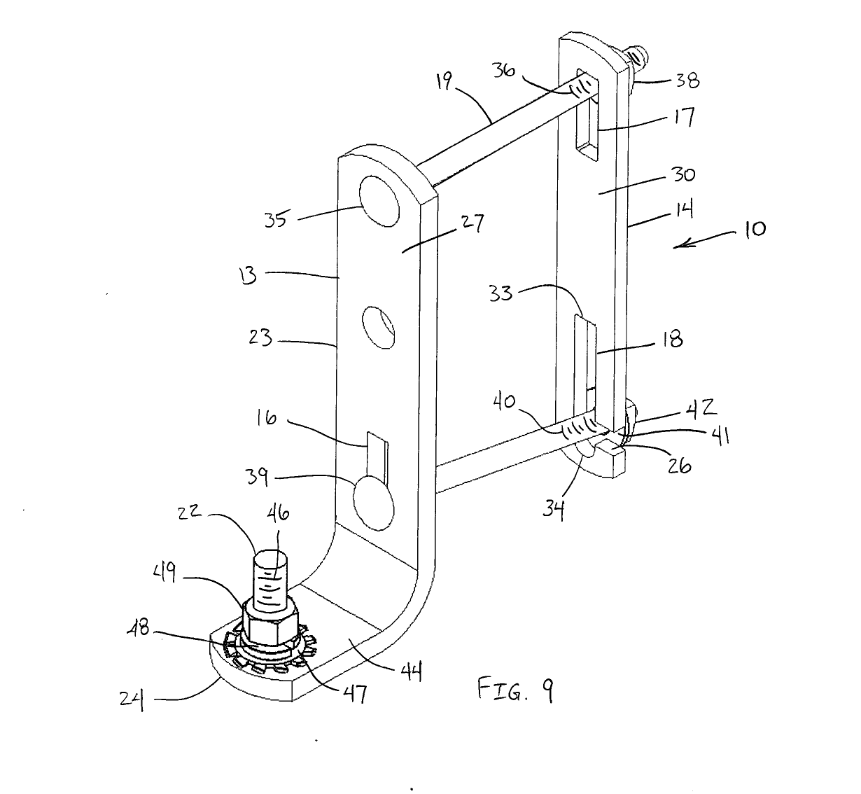

The first fastener 19 is received by the first opening 15 in the bracket 13 and the third fastener opening 17 in the back plate 14, as shown in FIGS. 7 and 15. A head 35 of the first fastener 19 is larger than the first opening 15 to prevent the first fastener from completely passing through the bracket 13. A threaded portion 36 of the first fastener 19 receives a washer 36 and nut 37, as shown in FIG. 15, to prevent axial movement of the first fastener in the removal direction by having diameters greater than the width of the third fastener opening 17.

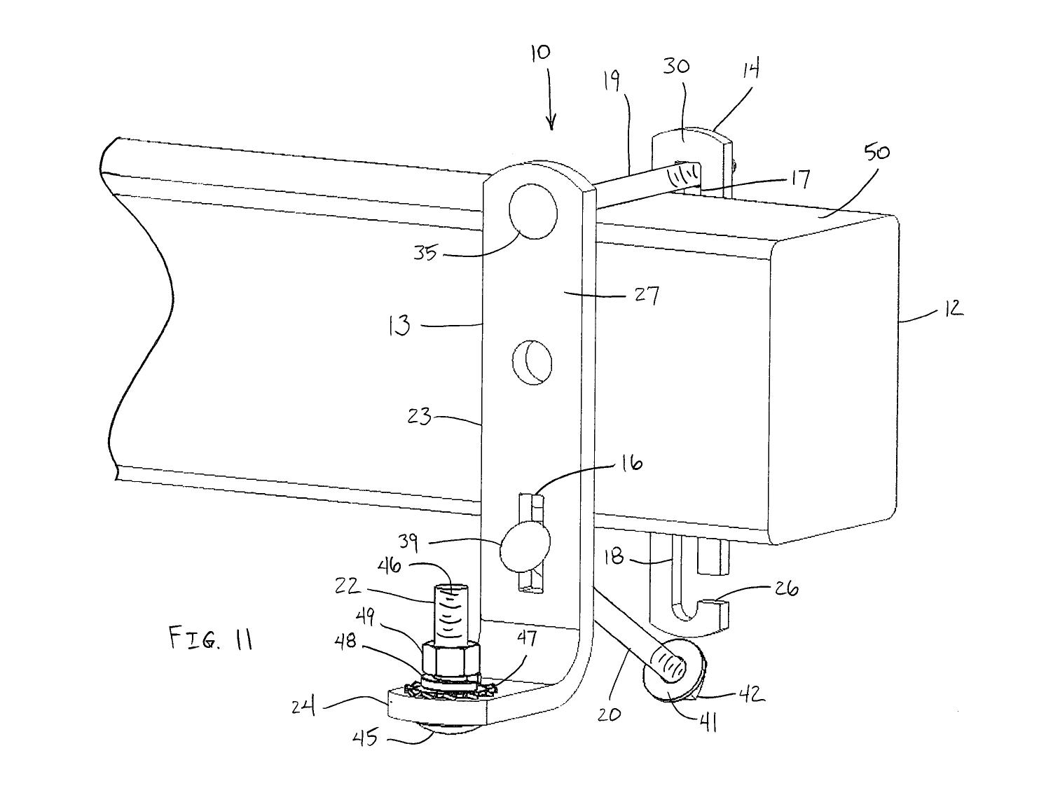

The second fastener 20 is received by the second opening 16 in the bracket 13 and the fourth fastener opening 18 in the back plate 14, as shown in FIGS. 10 and 15. A head 39 of the second fastener 20 is larger than the lateral width of the second opening 16 to prevent the second fastener from completely passing through the bracket 13. A threaded portion 40 of the second fastener 20 receives a washer 41 and a nut 42, as shown in FIG. 15, to prevent axial movement of the second fastener in the removal direction by having a diameter greater than the width of the fourth fastener opening 18.

A third fastener 22 is received by the fifth fastener opening 25 in the second leg 24 of the bracket 13, as shown in FIGS. 1 and 2. The third fastener 22 is adapted to receive a mounting member 21 of the electrical device, as shown in FIGS. 16-18. The second leg 24 has a lower surface 43 and an upper surface 44, as shown in FIGS. 1 and 2. The third fastener 22 has a head 45 larger than the fifth opening 25 to prevent the third fastener from completely passing through the second leg 24 of the bracket 13. A threaded portion 46 of the third fastener 22 receives a first lock washer 47, a second lock washer 48 and a nut 49, thereby preventing axial movement of the third fastener in the removal direction. Preferably, the first lock washer 47 is an external toothed lock washer having a plurality of outwardly extending teeth 50. The second lock washer 48 is preferably a split lock washer. The first and second lock washers 47 and 48 can be any suitable lock washers to prevent rotational movement of the third fastener 22, thereby securely mounting the electrical device 11 to the bracket assembly 10.

Preferably, the bracket 13 and the back plate 14 are made of metal, such as, but not limited to, steel. The bracket 13 is preferably unitarily formed as a one-piece member. The back plate 14 is preferably unitarily formed as a one-piece member.

### Assembly and Operation

The assembled bracket assembly 10 is shown in FIGS. 1 and 8-18. The first fastener 19 is received by the first and third fastener holes 15 and 17 in the bracket 13 and back plate 14, respectively. The second fastener 20 is received by the second and fourth fastener holes 16 and 18 in the bracket 13 and back plate 14, respectively. The third fastener 22 is received by the fifth fastener hole 25 (FIG. 3) in the second leg 24 of the bracket 13.

To preassemble the bracket assembly 10, the first fastener 19 is passed through the first fastener hole 15 in the mounting bracket 13 and through the third fastener hole 17 in the back plate 14, as shown in FIG. 7. The head 35 of the first fastener 19 prevents the first fastener from completely passing through the mounting bracket 13. The washer 37 and nut 38 are disposed on the threaded portion 36 of the first fastener 19, thereby preventing axial movement of the first fastener in a removal direction.

The second fastener 29 is passed through the second fastener hole 16 in the mounting bracket 13 and through the fourth fastener hole 18 in the back plate 14, as shown in FIG. 10. The head 39 of the second fastener 20 prevents the second fastener from completely passing through the mounting bracket 13. The washer 41 and nut 42 are disposed on the threaded portion 40 of the second fastener 20, thereby preventing axial movement of the second fastener in a removal direction.

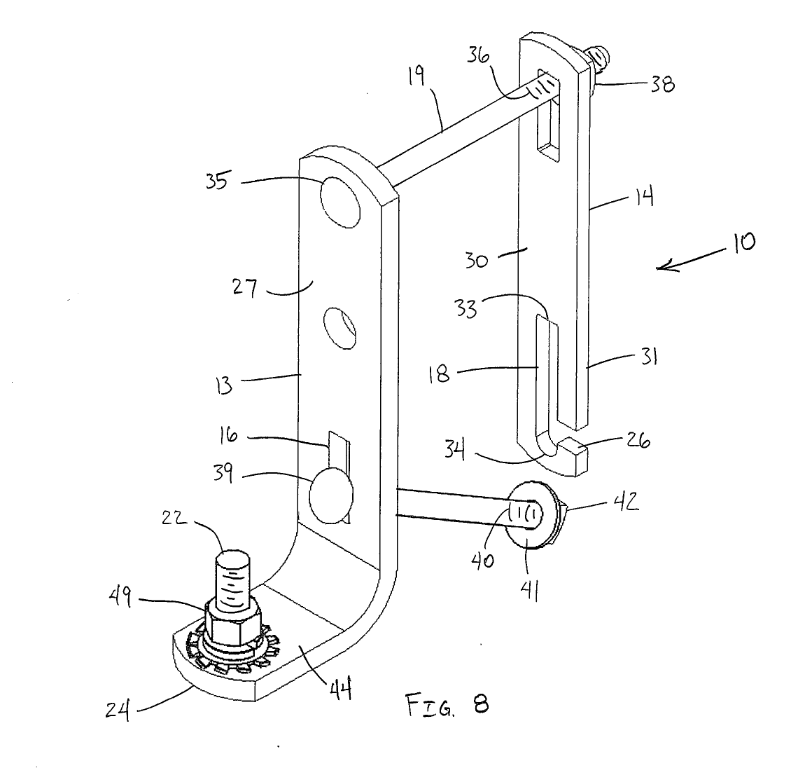

The third fastener 22 is passed through the fifth fastener hole 25 (FIG. 3) in the second leg 24 of the mounting bracket 13, as shown in FIG. 6. The fastener head 45, as shown in FIG. 3, abuts a lower surface 43 of the second leg 24, thereby preventing the third fastener from completely passing through the bracket 13. First and second lock washers 47 and 48 and a nut 49 are disposed on the third fastener 22, thereby preventing axial movement of the third fastener in a removal direction. The first lock washer 47 abuts an upper surface 47 of the second leg 24 of the bracket 13.

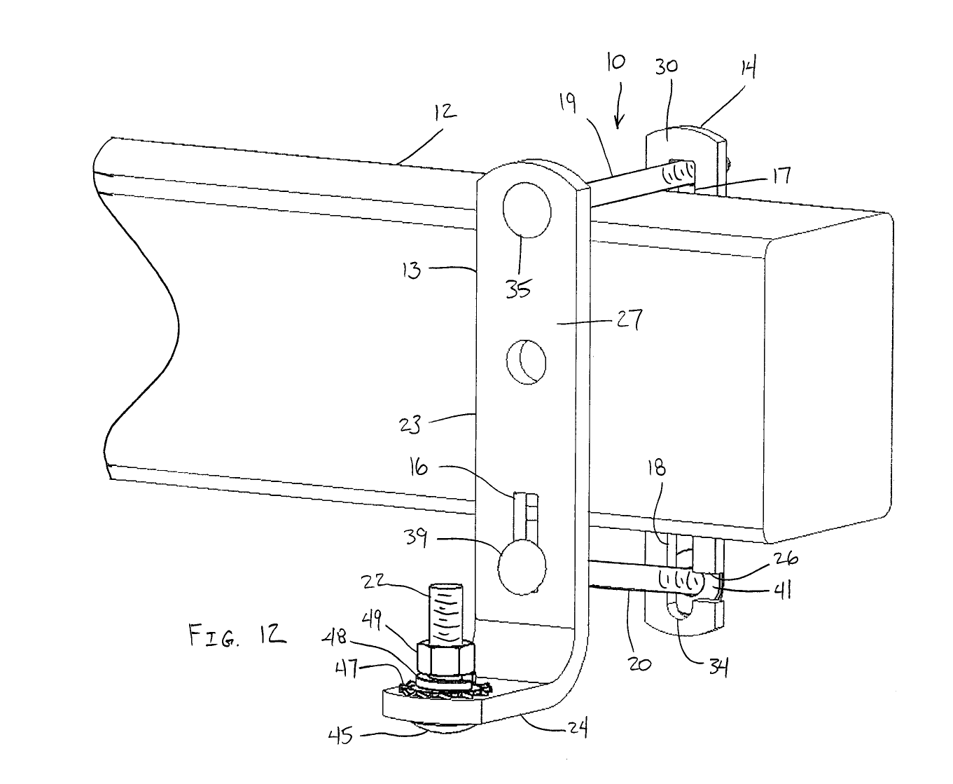

To secure the bracket assembly 10 to a support 12, such as a crossarm, the second fastener 20 is removed from the fourth fastener hole 18 by moving the second fastener out through the slot 26 in the back plate 14, as shown in FIG. 11. Thus, the second fastener 20 can be removed from the back plate 14 without requiring the washer 41 and nut 42 to be removed. The fastener head 39 and the washer 41 and nut 42 prevent the second fastener from being removed from the bracket 13.

The bracket assembly 10 is then slipped onto the support 12 laterally at any point along its length such that the first fastener 19 is disposed on an upper surface 50 of the support 12. The bracket assembly 10 is supported on the support 12 by the first fastener 19 on the upper surface 50 of the support 12 without being held by the installer. The second, third and fourth fastener holes 16, 17 and 18 are elongated to adjustably receive the first and second fasteners 19 and 20 therein, thereby allowing the bracket assembly 10 to be secured to supports 12 of various sizes. By hanging the bracket assembly 10 on the support, a lineman does not have to use a hand to ensure that the bracket assembly remains on the support.

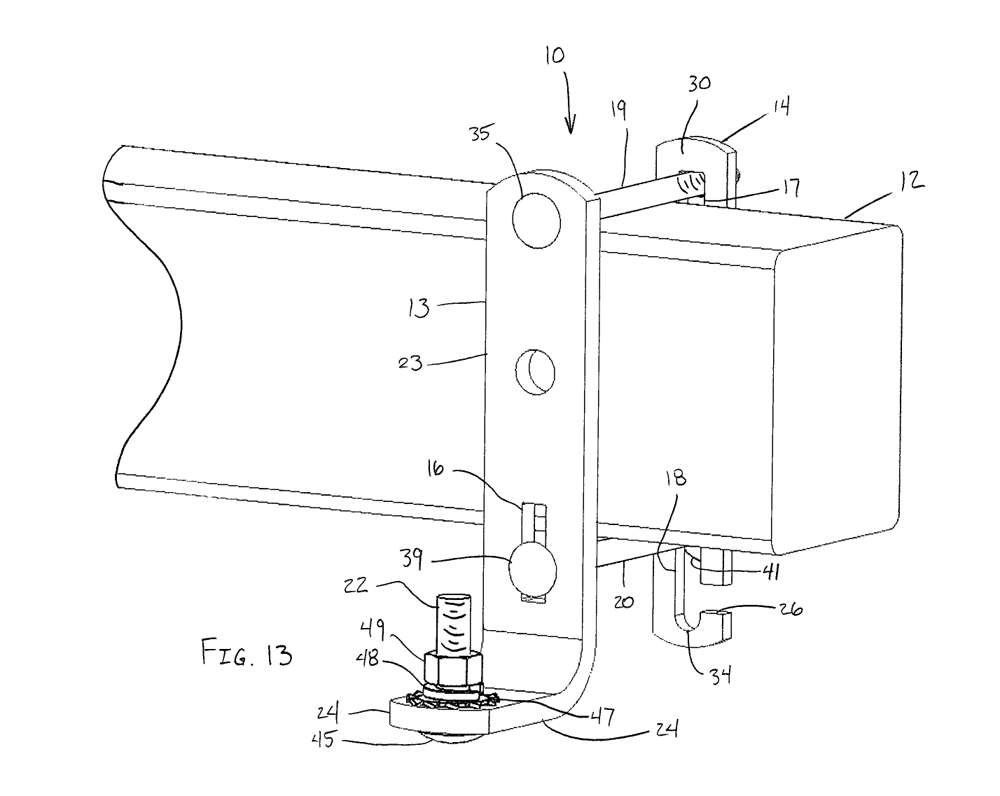

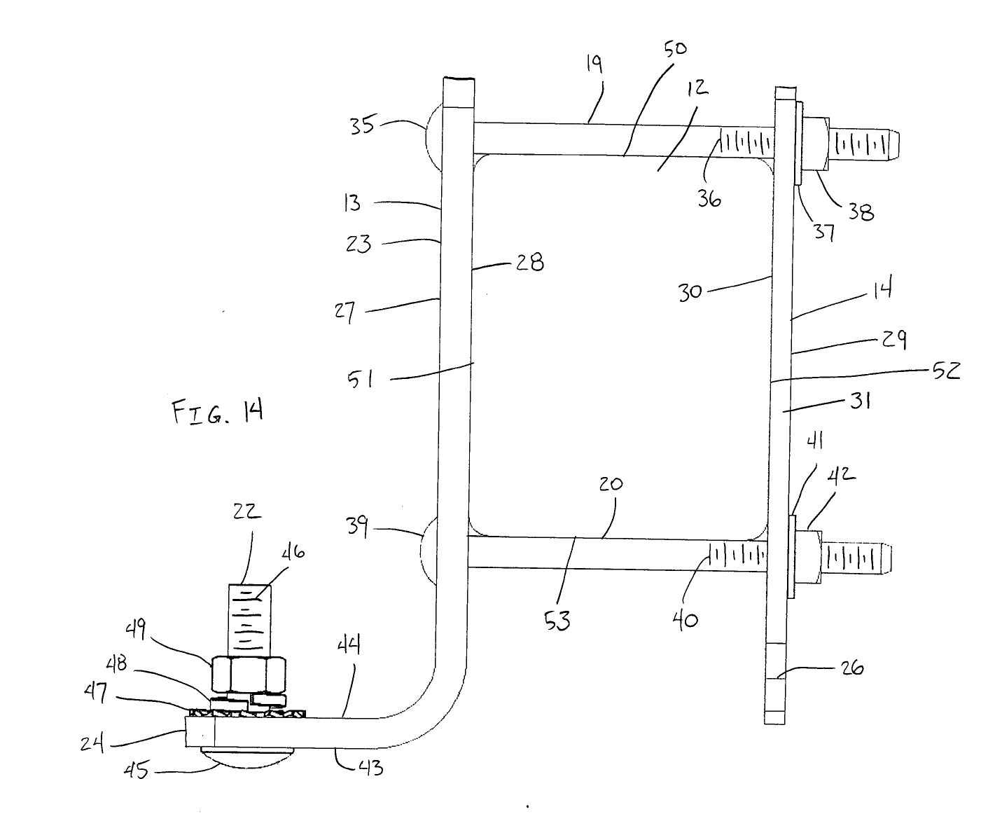

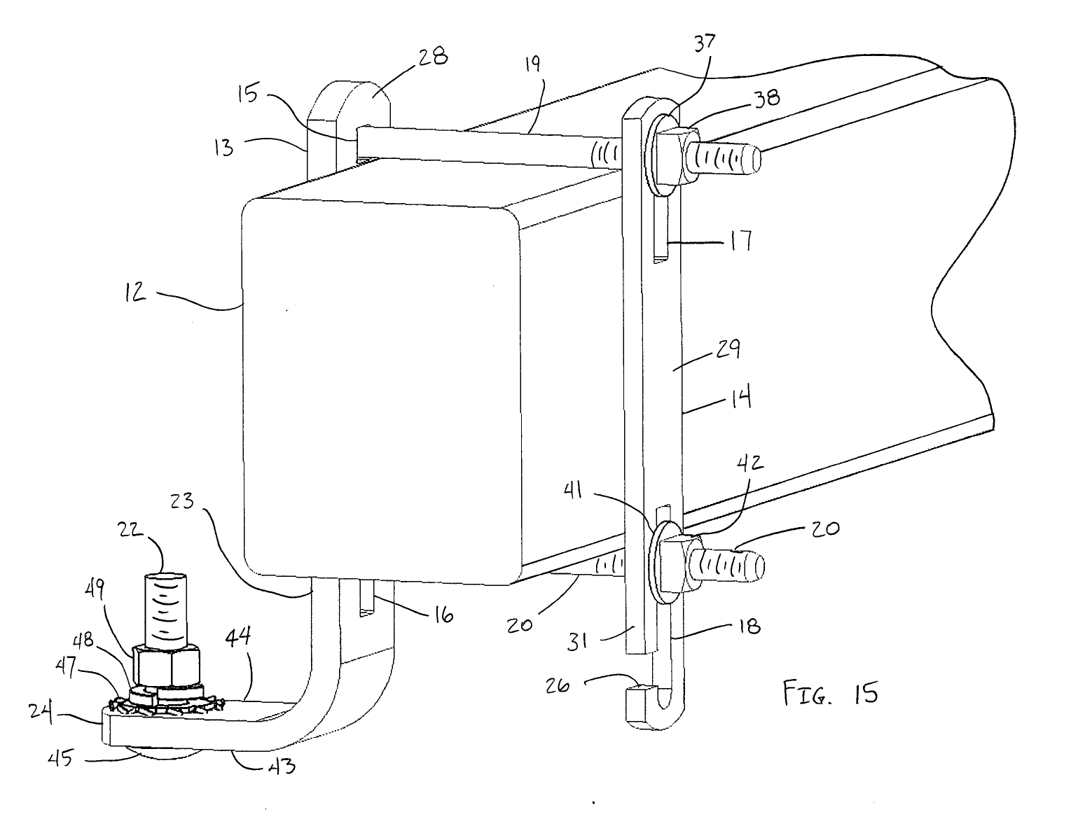

The second fastener 20 is then moved through the slot 26 and into the fourth fastener opening 18, as shown in FIGS. 12-15. The slot 26 is formed in a lateral edge 31 of the back plate 14 adjacent lower end 39 such that the slot 26 is not parallel to a longitudinal axis 32 (FIG. 5) of the back plate 14 and is axially spaced or not laterally aligned with the second fastener in its secured position shown in FIGS. 13 and 14. The sides of opening 18 prevent the second fastener 20 from sliding out of the opening 18. Thus, when the second fastener 20 falls in the fourth fastener opening 18, the second fastener 20 is caught by the second end 34 of the fourth fastener opening 18, thereby preventing the second fastener from falling out of the back plate 14. The first and second fasteners 19 and 20 are adjusted in the second, third and fourth elongated fastener openings 16, 17 and 18 and the nuts 38 and 42 tightened such that a tight fit is created with the support 12. The inner surface 28 of the bracket 13 contacts a first edge 51 of the support 12 and the inner surface 30 of the back plate contacts a second edge 52 of the support 12, as shown in FIG. 14. A lower surface 53 of the support 12 contacts the second fastener 20.

The electrical device 11 can then be secured to the mounted bracket assembly 10, as shown in FIGS. 16-18. An opening in the mounting member 21 is aligned with the fifth opening 25 (FIG. 3) in the second leg 24 of the bracket 13. The third fastener 22 is inserted through the aligned openings such that the head 45 of the third fastener contacts the lower surface 43 of the second leg 24 of the bracket 13. First and second lock washers 47 and 48 are disposed on the third fastener 22 such that the first lock washer 47 contacts the upper surface 44 of the second leg 24 of the bracket 13. A nut 49 is threadably disposed on the third fastener 22 to securely retain the electrical device 11 to the bracket assembly 10.

The foregoing embodiment and advantages are merely exemplary and are not to be construed as limiting the scope of the present invention. The description of an exemplary embodiment of the present invention is intended to be illustrative, and not to limit the scope of the present invention. Various modifications, alternatives and variations will be apparent to those of ordinary skill in the art, and are intended to fall within the scope of the invention as defined in the appended claims and their equivalents.

What is claimed is:

1. A bracket assembly for mounting an electrical device to a support, comprising:
a bracket having first and second fastener openings, said second fastener opening being elongated;
a back plate having third and fourth fastener openings, said third fastener opening being closed and said fourth fastener opening being elongated and open, a slot being disposed in said back plate for accessing said fourth fastener opening;
a first fastener received in said first and third fastener openings; and
a second fastener received in said second and fourth fastener openings.

2. The bracket assembly according to claim 1, wherein
said bracket has a fifth fastener opening for receiving a third fastener for securing the electrical device to said bracket assembly.

3. The bracket assembly according to claim 1, wherein
said bracket is unitarily formed as one-piece member.

4. The bracket assembly according to claim 1, wherein
said back plate is unitarily formed as a substantially planar one-piece member.

5. The bracket assembly according to claim 1, wherein
said slot extends in a direction substantially perpendicular to a longitudinal axis of said fourth fastener opening.

6. The bracket assembly according to claim 1, wherein
said bracket has a first leg and a second leg such that said bracket is substantially L-shaped.

7. The bracket assembly according to claim 6, wherein
said first and second fastener openings are disposed in said first leg.

8. The bracket assembly according to claim 7, wherein
said first leg of said bracket is substantially parallel to said back plate.

9. The bracket assembly according to claim 7, wherein
a fifth fastener opening for receiving a third fastener for securing an electrical device to said bracket assembly is disposed in said second leg of said bracket.

10. The bracket assembly according to claim 1, wherein
said fourth fastener opening is open between first and second ends thereof.

11. The bracket assembly according to claim 1, wherein
said third fastener opening is elongated.

12. A bracket assembly for mounting an electrical device to a support, comprising:
a substantially L-shaped bracket having first and second legs, first and second laterally closed fastener openings being disposed in said first leg, said second fastener opening being elongated;
a substantially planar back plate having third and fourth fastener openings, said third fastener opening being laterally closed and said fourth fastener opening being elongated and laterally open via a slot disposed in said back plate for accessing said fourth fastener opening and extending in a direction not parallel to a longitudinal axis of said fourth fastener opening;
a first fastener received in said first and third fastener openings; and
a second fastener received in said second and fourth fastener openings.

13. The bracket assembly according to claim 12, wherein
a fifth fastener opening for receiving a third fastener for securing the electrical device to said bracket assembly is disposed in said second leg of said bracket.

14. The bracket assembly according to claim 12, wherein
said bracket is unitarily formed as one-piece member.

15. The bracket assembly according to claim 12, wherein
said back plate is unitarily formed as a one-piece member.

16. The bracket assembly according to claim 12, wherein
said third fastener opening is elongated.

17. The bracket assembly according to claim 12, wherein
said fourth fastener opening is open between first and second ends thereof.

18. The bracket assembly according to claim 12, wherein
said slot extends in a direction substantially perpendicular to said longitudinal axis of said fourth fastener opening.

19. A method of mounting an electrical device to a support with a bracket assembly, comprising the steps of
mounting the bracket assembly on a support such that a first fastener contacts the support to support the bracket assembly on the support; and
moving a second fastener through a slot and into a first elongated fastener opening, the slot being not parallel with a longitudinal axis of the first elongated fastener opening.

20. The method of mounting an electrical device to a support with a bracket assembly according to claim 19, further comprising
moving the first fastener in a second elongated fastener opening and the second fastener in the first elongated fastener opening to accommodate supports of various sizes.
